(19) United States
(12) Patent Application Publication
(10) Pub. No.: US 2015/0103845 A1
(43) Pub. Date: Apr. 16, 2015

(54) SYNCHRONIZATION TIME-DIVISION MULTIPLEXING BUS COMMUNICATION METHOD ADOPTING SERIAL COMMUNICATION INTERFACE

(71) Applicants: STATE GRID CORPORATION OF CHINA (SGCC), Beijing (CN); STATE GRID ZHEJIANG ELECTRIC POWER COMPANY, Hangzhou, Zhejing (CN); Wenzhou Electric Power Supply Company of State Grid Zhejiang Electric Power Company, Wenzhou, Zhejiang (CN); JIANGSU XIDIANNAZI SMART ELECTRIC POWER EQUIPMENT CO., LTD, Jiangsu (CN)

(72) Inventors: Zhe Wu, Wenzhou (CN); Rongzhu Chen, Wenzhou (CN); Ruihai Dai, Wenzhou (CN); Xi Liu, Wenzhou (CN); Qin Xu, Jiangsu (CN); Shen Zhao, Wenzhou (CN); Qun Lin, Wenzhou (CN); Zhen Yang, Wenzhou (CN); Jun Yan, Wenzhou (CN); Yongxian Sun, Jiangsu (CN); Honglei Xi, Wenzhou (CN); Sheng Zheng, Wenzhou (CN); Zhenyu Zhou, Wenzhou (CN)

(73) Assignee: JIANGSU XIDIANNANZI SMART ELECTRIC POWER EQUIPMENT CO., LTD, Jiangsu (CN)

(21) Appl. No.: 14/401,086

(22) PCT Filed: May 20, 2013
(86) PCT No.: PCT/CN2013/075926

§ 371 Date: Nov. 13, 2014

(30) Foreign Application Priority Data
Nov. 10, 2012 (CN) 201210382801.X

(51) Int. Cl. H04L 12/403

(52) U.S. Cl. CPC H04L 12/4035
USPC 370/421

(57) ABSTRACT

A synchronous time-division multiplexing bus communication method adopting a serial communication interface is provided, which applied to a system comprising a master and a plurality of slavers, each of which comprises a micro-control unit, which comprises a Serial Communication Interface (SCI) and a timer, and transmitting and receiving data lines of the master and the plurality of slavers are connected to the bus, wherein the method comprises: transmitting a downlink data message as required by the plurality of slavers; receiving, by the plurality of slavers, the downlink data message via the Serial Communication Interface (SCI); transmitting an uplink data message after a predetermined time interval, by one of the plurality of slavers; and repeating the process of transmitting an uplink data message after a predetermined time interval, by a second one to the last one of the plurality of slavers respectively.

The present application claims the priority to Chinese Patent Application No. 201210382801.X, entitled “SYNCHRONIZATION TIME-DIVISION MULTIPLEXING BUS COMMUNICATION METHOD ADOPTING SERIAL COMMUNICATION INTERFACE”, filed Oct. 11, 2012 with the Chinese State Intellectual Property Office, which is incorporated herein by reference in its entirety.

### TECHNICAL FIELD

The present disclosure relates to a method for bus communication, and in particular to a synchronous time-division multiplexing bus communication method adopting serial communication interface.

### BACKGROUND

In industrial control, plenty of input interfaces and output interfaces are generally used in automatic devices, in order to acquire various sensor signals and binary signals. The input interfaces and output interfaces also act as an output of the automatic devices for controlling relays. Usually, the input interfaces and output interfaces are embodied as a main control board or an input and output board.

In traditional technology, each channel of the input and output board is directly connected to a MCU pin of the main control board, hence the MCU pins should be adequate. Also, the number of the input and output interfaces varies with different application scenarios, hence the compatibility of the control board compatibility may be degraded.

At present, a bus for the communication between the input and output board and the main control board has been widely used in the automatics.

A MCU is installed in the input and output board to process input and output signals and to communicate with the MCU of the main control board. Hence, the structure of the internal bus of the automatic device determines its timeliness and stability.

However, the traditional serial or parallel communications can not meet the requirement of real-time communication in intensive interference. Hence, the manufactures begin to develop the buses of their own devices to meet the requirement of real-time communication in intensive interference. There are various kinds of internal buses, such as parallel bus and serial bus. The various buses are realized by FPGA, CPLD or other MCUs. SPI interfaces, SCIs (Serial Communication Interface) or CAN interfaces are adopted in the various buses.

It is difficult to develop a structure-simplized and qualified bus for those messages, between the input and output board and the main control board, which have a fixed and not long length, hence the real-time communication can not be realized.

In view of this, many manufacturers adopted the TDM (Time-Division Multiplexing) bus technology to develop the bus. For example, in Chinese Patent Application No. 200420025265.9 (Publication Number CN2710264), it is disclosed a time-division multiplexing real-time communication bus, which adopts SPI. This bus includes: MOSI data lines, MISO data lines and SCK data clock signal lines in the master, slavers and SPI communication buses, and SPI communication chip select control lines (SS). This bus includes a determination module. The MOSI data lines, MISO data lines and SCK data clock signal lines of the master are connected with the MOSI data lines, MISO data lines and SCK data clock signal lines of the slavers, respectively. The SCK data clock signal lines of the master are connected with not only the SCK data clock signal lines of the slavers, but also the determination modules which the slavers are homed to. The output control lines of the determination modules are connected with the SPI communication chip select control lines (SS) of the corresponding slavers.

In this communication bus, because signals are transmitted in different timeslots, a plurality of digital signals can be transmitted in one physical channel, and hence the compatibility of the automatic device is expanded, especially in the case of a large amount of binary input and output.

Although this communication bus realizes the real-time communication, it has a complicated hardware circuit and circuitry. The MCU hardware is required to be more qualified for realizing the bus function, which results in a complicated implementation, an increased use cost, a difficulty to control the real-time performance, and the reduced communication reliability and the bus transmission rate due to the influence on real-time performance.

In view of this, in any internal bus mode where the additional high-speed logic chip is adopted to increase the transmission rate and reliability of the bus, where multiple data lines and the additional circuit are adopted to guarantee the transmission rate and reliability of the bus, or where the transmission rate and the reliability of the bus are balanced as needed, the MCU needs to be more qualified, which results in the complicated hardware circuit, and the susceptibility to hardware device. Hence the communication reliability and transmission rate of the bus are restrained, and the high-reliability and high-transmission rate real-time communication can not be realized.

### SUMMARY

In view of the disadvantages in the conventional art, an object of the disclosure is to provide a synchronous time-division multiplexing bus communication method adopting a serial communication interface. In the synchronous time-division multiplexing bus communication method, based on internal buses that most MCUs have, only two physical lines are adopted to implement high-reliability differential connections and to meet the high-speed real-time requirements, which addresses the issue of bus communication between modules within a device, realizes the real-time communication controllability, reduces the complexibility of hardware circuit, and enhances the compatibility and reliability of the circuit.

For achieving the above object, the disclosure provides the technical solutions as follows.

An embodiment of the invention provides a synchronous time-division multiplexing bus communication method adopting a serial communication interface. This method may be applied to a system including a master and multiple slavers, each of which includes a micro-control unit which includes a Serial Communication Interface (SCI) and a timer, and transmitting and receiving data lines of the master and multiple slavers are connected to the bus. The method includes:

transmitting a downlink data message as required by the multiple slavers;

receiving, by the multiple slavers, the downlink data message via the Serial Communication Interface (SCI);

transmitting an uplink data message after a predetermined time interval, by one of the multiple slavers; and

repeating the process of transmitting an uplink data message after a predetermined time interval, by a second one to the last one of the multiple slavers respectively.

Preferably, the process of transmitting an uplink data message by one of the multiple slavers includes:

determining, by the slaver, whether the downlink data message is transmitted from the master on receiving the downlink data message;

refraining from processing the downlink data message in the case of a negative determination and receiving another downlink data message, by the slaver;

initiating the timer in the case of a positive determination and performing a data check on the received downlink data message, by the slaver;

closing the timer in the case that the received downlink data message does not pass the data check and receiving another downlink data message by the slaver; and

processing the downlink data message by the slaver in the case that the received downlink data message passes the data check, and transmitting the data message via the Serial Communication Interface (SCI) by the slaver once the time set by the timer expires.

Preferably, the bus converts the bus physically into differential lines by a single-ended-to-differential signal conversion chip, and the master and the slavers are connected to the bus via the differential lines.

Preferably, a time interval between two data message transmissions from the master and from the slavers is the predetermined time interval.

Preferably, the bus is configured to operate in a half-duplex communication mode.

Compared with the conventional art, the disclosure has the advantages as follows.

With this method, the bus has a simple physical structure, that is, only two differential lines are adopted for realizing a high-reliability real-time bus communication and meeting high-speed real-time requirements, and even a single signal line can realize such communication in the case of weak external interference. The bus can be implemented under a low requirement for MCU hardware, that is, any MCU having an SCI interface and a timer can be qualified. Different baud rates and idle times are selected by different slavers in practice for meeting the real-time requirements. In the synchronous time-division multiplexing, the master fills in the data memory at the time interval, which simplifies the program for processing bus data from the slavers. The messaging frequency of the master is the same as that of the slavers. Each time that the master transmitting a message, the time point for messaging of the slavers is matched, which guarantees the accuracy of messaging frequency of the slavers and provides the selection of unfixed cycle based on the work load of the master without resulting in asynchronousness of the slavers. The method addresses the issue of bus communication between modules within a device, realizes the real-time communication controllability, reduces the complexibility of hardware circuit, and enhances the compatibility and reliability of the circuit.

### BRIEF DESCRIPTION OF THE DRAWINGS

FIG. 1 is a schematic diagram of a system according to an embodiment of the invention;

FIG. 2 is a frame format diagram of a message with an address bit according to an embodiment of the invention;

FIG. 3 is a flowchart of a communication according to an embodiment of the invention; and

FIG. 4 is a flowchart of transmitting an uplink data message from a slaver according to an embodiment of the invention.

### DETAILED DESCRIPTION

In order to clarify the technical solutions, creative features, objects and advantages according to the disclosure, hereinafter is described in conjunction with embodiments.

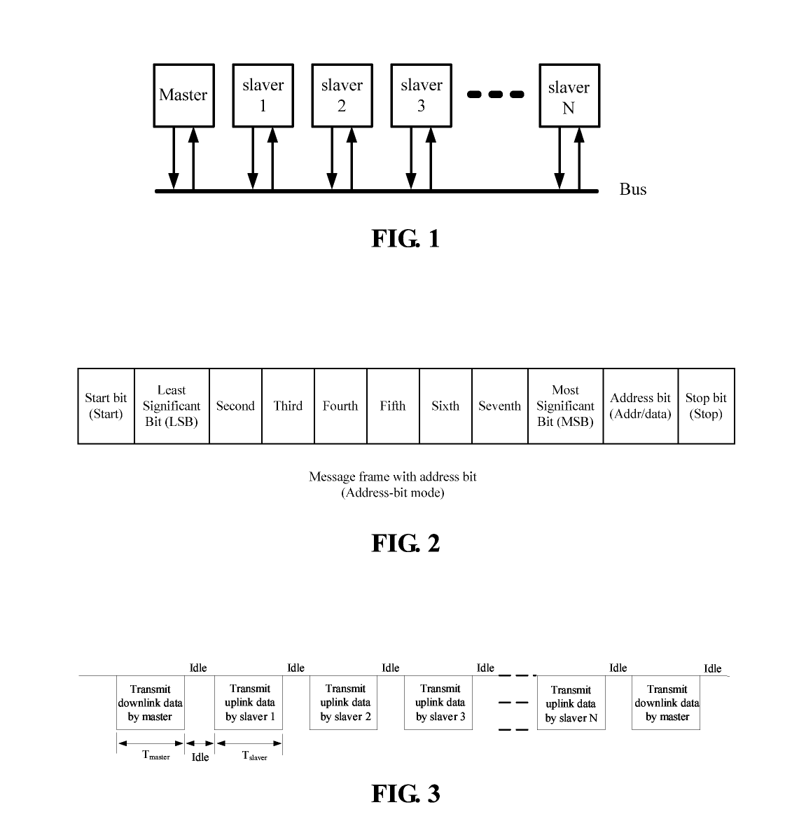

FIG. 1 is a schematic diagram of a system where a method according to an embodiment of the invention is used.

A synchronous time-division multiplexing bus communication method adopting a serial communication interface is provided according to an embodiment of the invention, which solves the bus communication problem of internal modules of a device.

In this method, the bus is configured to operate in a half-duplex communication mode, which can not only realize a high-reliability and real-time bus communication, but also meet an requirement of high real-time transmission rate.

In this embodiment, the transmitting and receiving data lines of the master and multiple slavers are connected to the bus, where only one device occupies the bus to transmit data at a time point, and the other devices receive data.

In order to enhance the communication reliability and reduce the bit error rate, the bus converts the bus physically into differential lines by a single-ended-to-differential signal conversion chip, i.e., the transmitting and receiving data lines are the differential lines, and the master and the slavers are connected to the bus via the differential lines.

FIG. 2 is a frame format diagram of a message with an address bit according to an embodiment of the invention.

The message frame includes 1 bit of start bit (Start), and 8 bits of data bit, where LSB is the first bit of the data bits, the “second” to “seventh” bits are the second to the seventh bits of the data bits, and MSB is a low bit of the data bits. The message also includes 1 bit of address bit (Add/data), and 1 bit of stop bit (Stop).

In the communication according to the embodiment of the invention, a message frame with an address bit is adopted. The communication includes the process as follows.

A communication loop includes uplink messaging and downlink messaging. If a downlink message is transmitted, the address bit is 1, representing that the message is transmitted from a master to a slaver.

In a manner of one master to multi-slaver, the master transmits a message to the slavers, each slaver reads desired information from the received message. The frequency of transmitting downlink message acts as the operating frequency of the slavers.

In case of uplink messaging, the address bit is 0, representing that the message is transmitted from the slavers to the master in a time-division multiplexing manner.

On receiving a message with the address bit being 1, the slaver delays a period of time in view of its own address number and transmits an uplink message, thereby realizing multiplexing.

On receiving a message with the address bit being 0, the slaver does not process the message.

In this embodiment, Tₘₐₛₜₑᵣ represents a period of time during which the master transmits a downlink message. Tₛₗₐᵥₑ represents a period of time during which each slaver transmits an uplink message. Idle represents a time interval between Tₘₐₛₜₑᵣ and Tₛₗₐᵥₑ.

FIG. 3 is a schematic diagram of a synchronous time-division multiplexing bus communication method adopting a serial communication interface according to an embodiment of the invention.

In this embodiment, the synchronous time-division multiplexing bus communication method adopting a serial communication interface is described as follows:

A master transmits a downlink data message. Slaver 1 receives the downlink data message via the serial communication interface, i.e., an SCI interface. After an Idle time interval, Slaver 1 begins to transmit an uplink data message. After an Idle time interval, slaver 2 begins to transmit an uplink data message. Similarly, after an Idle time interval, slaver N begins to transmit an uplink data message. After an Idle time interval, the master begins to transmit a second downlink data message. In this process, a data communication is realized.

In conclusion, Idle represents the interval time between two data message transmissions from the master and the slavers.

A slaver begins to receive a data message via SCI, and determine whether the received data message is transmitted from the master based on the address bit of the data message. If the received message is not transmitted from the master, but a message from the other slavers, the slaver does not process the message. If the received message is transmitted from the master, the slaver initiates a timer (the set time of the timer is determined by Idle, Tₛₗₐᵥₑᵣ and N) and performs a data check on the received data message. If the received data message does not pass the check, the slaver closes the timer, and continues to receive data from the bus. If the received data message passes the check, the slaver begins to process the received data. When the set time of the timer expires, the slaver transmits a data message via SCI.

The time point for transmitting a message is calculated as follows:

The time point tₙ for the Nth slaver to transmit a message is given according to the formula (1) below:

tₙIdle+(Idle+Tₛₗₐᵥₑᵣ)*(n−1) (1)

where, n is the address number (1 . . . N).

The cycle of one communication loop is given according to the formula (2) below:

T=Tₘₐₛₜₑᵣ+Idle+(Idle+Tₛₗₐᵥₑᵣ)*n (2)

where, n is the address number (1 . . . N)

Based on system requirements, the cycle T of one communication loop and the maximum amount of slavers are determined, and appropriate baud rate and idle time are selected, so that a data communication within a specified period of time is realized.

For example, the communication cycle in the system is 500 us currently, the maximum amount of slavers is 10, the baud rate is set to 3.75 mbps, the length of downlink message from the master is 16 bits, and the length of uplink message from the slaves is 10 bits, and thus the time interval between two data message transmissions from the master and from the slavers, Idle=[500−(16×11/3.75)−10×(10×11/3.75)]/(10+1)≈14.5 us.

The 500 us-cycle real-time communication is realized by setting the waiting time of slavers.

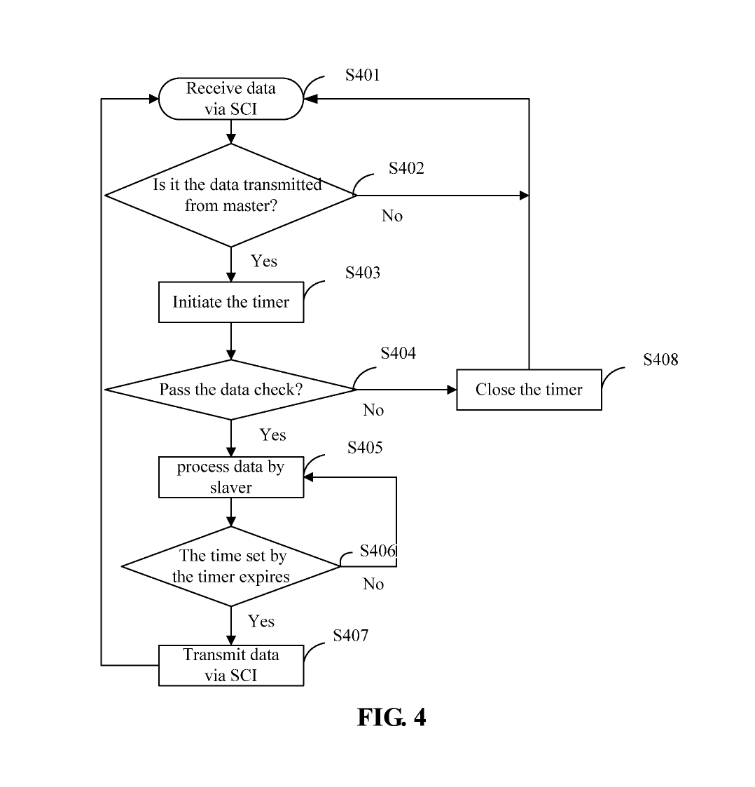

FIG. 4 is a flowchart of transmitting an uplink data message from a slaver according to an embodiment of the invention.

In step S401, data is received via SCI.

In step S402, the slaver determines whether the received data is transmitted from the master, performs Step S403 in the case of a positive determination, or performs Step S408 in the case of a negative determination.

In step S403, a timer is initiated.

In step S404, the slaver determines whether the received data passes a data check, performs Step S405 in the case of a positive determination, or performs Step S408 in the case of a negative determination.

In step S405, the slaver processes the data.

In step S406, the slaver determines whether the time set by the timer expires, performs Step S407 in the case of a positive determination, or performs Step S405 in the case of a negative determination.

In step S407, the slaver transmits data via SCI; and

In step S408, the timer is closed.

In conclusion, in this disclosure, the bus has a simple physical structure, that is, only two differential lines are adopted for realizing a high-reliability real-time bus communication, and even a single signal line can realize such communication in the case of weak external interference. The bus can be implemented under a low requirement for MCU hardware, that is, any MCU having an SCI interface and a timer can be qualified. Different baud rates and idle times are selected by different slavers in practice for meeting the real-time requirements. In the synchronous time-division multiplexing, the master fills in the data memory at the time interval, which simplifies the program for processing bus data from the slavers. The messaging frequency of the master is the same as that of the slavers. Each time that the master transmitting a message, the time point for messaging of the slavers is matched, which guarantees the accuracy of messaging frequency of the slavers and provides the selection of unfixed cycle based on the work load of the master without resulting in asynchronousness of the slavers.

The above are only preferable embodiments of the present invention, and should not be interpreted as limiting the present invention. Although the present invention is disclosed as the above preferable embodiments, which should not be interpreted as limiting the present invention. By using the disclosed method and technical solution above, various improvements and modifications for the technical solution of the present invention can be made by those skilled in the art without departing from the scope of the present invention. Therefore, the content without departing from the technical solution of the present invention, the simply improvement, the equivalent change and modification for the above embodiments based on the technical essence of the present invention, are also intended to be embraced within the scope of protection of the invention.

1. A synchronous time-division multiplexing bus communication method adopting a serial communication interface, applied to a system comprising a master and a plurality of slavers, each of which comprises a micro-control unit, which comprises a Serial Communication Interface (SCI) and a timer, and transmitting and receiving data lines of the master and the plurality of slavers are connected to the bus, wherein the method comprises:
transmitting a downlink data message as required by the plurality of slavers;
receiving, by the plurality of slavers, the downlink data message via the Serial Communication Interface (SCI);
transmitting an uplink data message after a predetermined time interval, by one of the plurality of slavers; and
repeating the process of transmitting an uplink data message after a predetermined time interval, by a second one to the last one of the plurality of slavers respectively.

2. The synchronous time-division multiplexing bus communication method adopting a serial communication interface according to claim 1, wherein the process of transmitting an uplink data message by one of the plurality of slavers comprises:
determining, by the slaver, whether the downlink data message is transmitted from the master on receiving the downlink data message;
refraining from processing the downlink data message in the case of a negative determination and receiving another downlink data message, by the slaver;
initiating the timer in the case of a positive determination and performing a data check on the received downlink data message, by the slaver;
closing the timer in the case that the received downlink data message does not pass the data check and receiving another downlink data message by the slaver; and
processing the downlink data message by the slaver in the case that the received downlink data message passes the data check, and transmitting the data message via the Serial Communication Interface (SCI) by the slaver once the time set by the timer expires.

3. The synchronous time-division multiplexing bus communication method adopting a serial communication interface according to claim 1, wherein the bus converts the bus physically into differential lines by a single-ended-to-differential signal conversion chip, and the master and the slavers are connected to the bus via the differential lines.

4. The synchronous time-division multiplexing bus communication method adopting a serial communication interface according to claim 1, wherein a time interval between two data message transmissions from the master and from the slavers is the predetermined time interval.

5. The synchronous time-division multiplexing bus communication method adopting a serial communication interface according to claim 1, wherein the bus is configured to operate in a half-duplex communication mode.

6. The synchronous time-division multiplexing bus communication method adopting a serial communication interface according to claim 2, wherein the bus converts the bus physically into differential lines by a single-ended-to-differential signal conversion chip, and the master and the slavers are connected to the bus via the differential lines.

7. The synchronous time-division multiplexing bus communication method adopting a serial communication interface according to claim 2, wherein a time interval between two data message transmissions from the master and from the slavers is the predetermined time interval.

8. The synchronous time-division multiplexing bus communication method adopting a serial communication interface according to claim 2, wherein the bus is configured to operate in a half-duplex communication mode.
